(19) United States
(12) Patent Application Publication
(10) Pub. No.: US 2008/0184906 A1
(43) Pub. Date: Aug. 7, 2008

(54) Long range hybrid electric airplane

(76) Inventor: Joseph B. Kejha, Meadowbrook, PA (US)

Correspondence Address: JOSEPH B. KEJHA, 1022 Frederick Rd., Meadowbrook, PA, 19046, US

(21) Appl. No.: 11/703,362

(22) Filed: Feb. 7, 2007

(51) Int. Cl. B64C 11/00; F42B 15/00

(52) U.S. Cl. 102/374; 244/13; 903/903

(57) ABSTRACT

An advanced internal combustion-electric hybrid airplane, having at least double the flight range and flight duration than a conventional equivalent airplane, while using the same amount of any desirable fuel. This is achieved by using 2-3× smaller and ultra-lightweight engine for cruising, and ultra-lightweight electric motor powered by lithium batteries during take-off and climbing. The electric motor becomes a generator during cruising and descent, recharging said batteries. The airplane has also temporary silent electric stealth capability and added safety by the electric back-up power. Due to its high efficiency, the operational cost is substantially reduced. Additional features include highly advanced, minimum drag and weight airframe.

### CROSS REFERENCE TO RELATED DOCUMENTS

The subject matter of the invention is shown and described in the Disclosure Document of Joseph B. Kejha Ser. No. 569,743 filed on Feb. 7, 2005, and entitled “Long Range Hybrid Electric and Silent Electric Airplanes.”

### BACKGROUND OF THE INVENTION

1. Field of the Invention

This invention pertains to the construction of longer flight duration and longer flight range airplanes, on the same amount of any type of fuel; as compared to equivalent prior art airplanes. The airplanes of the invention also have a temporary silent flight capability in electric only mode of operation.

2. Description of the Prior Art

Prior art manned airplanes (MAVs) and unmanned airplanes (UAVs) of all sizes utilize powerful internal combustion internal combustion engines, which are necessary for take-off and climbing, but the same engines are oversized for cruising horsepower needs, and consume too much fuel, which shortens their flight range. Prior art airplanes with internal combustion engines have no regeneration of energy and its storage. By another words, they have low efficiency. Prior art aircraft engines, although much lighter than automobile engines are still too heavy, due to their size necessary for take-off and climbing power, and also due to relating heavy materials used in their construction. All this contributes to the shorter flight range. Prior art internal combustion engines are also very noisy and have a heat signature, which makes these airplanes in military missions easily detectable. Pure electric silent airplanes had been made, but they have short range and flight duration, due to the limited energy density of their batteries. Several hybrid electric airplanes are known, all in combination with solar electricity or fuel cells, which are expensive and weather dependent, or suffer from short life, and absence of the hydrogen infrastructure and lightweight hydrogen storage. None of them are practical for a rugged military or commercial use. Prior art electric motors and generators are also very heavy, due to the use of copper wires and solid steel shafts. Therefore, there is always a need to provide an airplane with longer flight range and/or flight duration on the same amount of fuel, while having silent stealth flight capability, and improved reliability and safety. Also there is a need to provide lighter engines and also lighter motors and generators. The airplanes and their propulsion systems of this invention do not suffer from prior art problems and provide for superior flight range, silent flight at the target, and additionally a safe power backup.

### SUMMARY OF THE INVENTION

It has now been found, that a longer flight range and longer flight duration airplane than conventional equivalent airplanes can be made by combining a smaller ultra-light internal combustion engine propulsion system with an ultra-light electric motor and generator propulsion system, powered by a lightweight battery, which propulsion combination provides for an internal combustion electric hybrid airplane system. This hybrid propulsion system can replace the large conventional internal combustion engine in combustion-only airplanes, or the electric motor in electric-only airplanes. Because in any combustion-only airplane the engine is designed for take-off and climbing power, the same engine is oversized for cruising power, and consumes too much fuel, and has no regeneration of energy and its storage. By another words, it has low efficiency of the system. In this electric hybrid, a small combustion engine is used only for cruising power and therefore can be approximately 2-3× smaller and thus can run 2-3× longer time on the same amount of fuel than the large engine. This results in 2-3× longer flight range. The hybrid can be a parallel hybrid, or a series hybrid.

The simplified operation of the parallel hybrid airplane is as follows:

For take-off and climb both, the electric motor/generator and the combustion engine are used to drive the propeller. The electric motor should be preferably powered by a high energy density rechargeable lithium-ion battery.

During horizontal flight, only the small engine is used for cruising and a small extra power is used to generate electricity and recharge the batteries.

During descent, the engine is disconnected by a clutch and stopped, the propeller becomes a windmill and drives the electric motor/generator and fully recharges the batteries, to be ready for the next take-off. It should be noted, that the final approach for landing should be done with the restarted engine, or the electric motor, or both.

This electric hybrid airplane has additional advantages useful to the military. It has a temporary stealth capability. It can fly long range mission to the target using the engine, but during the approach it can switch to silent electric mode, execute the task and silently depart. For an extended silent electric flight, optional, preferably lithium-air batteries may be added at the cost of reducing the fuel range, which loss is replaced by the electric range. The electric motor then restarts the engine via clutch, to fly long distance back to the home base, becoming a generator and charges the battery during the flight home. Added safety is in its electric power backed by the batteries, if the engine fails. The plane will not be lost.

The simplified operation of the series hybrid airplane is as follows:

During take-off and climb both, the engine/generator, and the battery supply electrical current to the electric motor, which drives the propeller. The electric motor is briefly overloaded 3×.

During horizontal flight, only the generator driven by 3× smaller engine delivers electrical current to the electrical motor and additionally charges the battery , while having approximately ⅓ of fuel consumption rate of an equivalent conventional airplane.

Before the approach to the target, the engine/generator is stopped and silent flight continues by the electrical motor powered by the battery. When the mission is completed, the aircraft silently departs on electric power only.

After a safe distance from the target, the generator becomes second electrical motor and restarts the engine, which starts driving the generator again, and recharges the battery during the flight home.

During descent for landing, the engine/generator is stopped. The propeller becomes a windmill and spins the first electric motor, which becomes a generator and fully recharges the battery, to be ready for the next take-off.

The battery is protected from overcharge by an electronic interface and if necessary, it can be also charged on the ground from the electric grid. The same safety is provided by the battery back up, similar to the parallel hybrid. Also the additional batteries may be similarly added, for the extended silent flight.

The whole propulsion system without the fuel should not weigh more than the comparable, large conventional combustion-only equivalent aircraft engine. To accomplish this, the small engine, electric motor and generator, its controls and batteries should be designed from scratch and made from ultra lightweight materials only. For example, magnesium engine crank case and electrical motor/generator casings, carbon-carbon/ceramic composite cylinder block, aluminum and titanium hollow shafts, lithium batteries, and disc armature high torque electrical motor/generator may have flat aluminum wires or copper plated graphite fiber wires, instead of copper.

In case of compressed hydrogen fuel, this airplane would fly about the same distance as an equivalent conventional plane with petroleum fuel, due to its efficiency, and at much lower production cost than an equivalent fuel cell hydrogen fueled airplane.

The airplane can be built in any size, including 20-60 kg UAV, or as a manned aircraft, preferably with the lowest possible drag carbon fiber airframe, like a diamond-wing, tandem bi-plane with all electric controls, which will compound the benefits of both. The batteries should be in the wings, reducing the bending moment of the lift, which results in a lighter airframe.

In a jet version, the jet engine may be combined with a series electric motor/ducted fan, having over 30,000 RPM. When this application is used in a cruise missile, it will have also the silent electric mode at the target, achieving a total surprise.

The principal object of this invention is to provide any type of airplane with longer flight range and longer flight duration than prior art airplanes on the same amount of any desirable fuel.

Another object of this invention is to provide an airplane with temporary silent flight capability and electric power backup.

Another object of this invention is to provide a hybrid electric-internal combustion airplane with minimal size, weight, and drag airplane for the given mission.

Other objects and advantages of the invention will be apparent from the description and claims.

### BRIEF DESCRIPTION OF THE DRAWINGS

The nature and characteristic features of the invention will be more readily understood from the following description taken in connection with the accompanying drawing forming part hereof in which:

FIG. 1 is a diagrammatic, side elevational view of the parallel hybrid electric propulsion system for airplanes, illustrating its components.

FIG. 2 is a diagrammatic, side elevational view of the series hybrid electric propulsion system for airplanes, illustrating its components.

FIG. 3 is a diagrammatic, side elevational view of the hybrid electric airplane incorporating the parallel internal combustion-electric hybrid puller propulsion systems.

FIG. 4 is a diagrammatic, side elevational view of the hybrid electric airplane incorporating the series internal combustion-electric hybrid pusher propulsion system.

FIG. 5 is a diagrammatic, top elevational view of the hybrid electric airplane shown in FIG. 4.

FIG. 6 is a diagrammatic, side elevational view of the hybrid electric airplane incorporating the parallel internal combustion-electric hybrid pusher propulsion systems.

FIG. 7 is a diagrammatic, top elevational view of the hybrid electric airplane shown in FIG. 6.

FIG. 8 is a diagrammatic, front elevational view of the hybrid electric airplane shown in FIG. 6.

FIG. 9 is a diagrammatic, side elevational, sectional view of the hybrid electric airplane incorporating the parallel jet combustion-electric hybrid propulsion system.

FIG. 10 is a diagrammatic, top elevational view of the hybrid electric airplane shown in FIG. 9.

FIG. 11 is a diagrammatic, rear elevational view of the hybrid electric airplane shown in FIG. 9.

FIG. 12 is a diagrammatic , side elevational , sectional view of the hybrid electric airplane incorporating the series jet combustion-electric hybrid propulsion system.

Like numerals refer to like parts throughout the several views and figures. It should, of course, be understood that the description and drawings herein are merely illustrative, and it will be apparent that various modifications, combinations and changes can be made of the structures and the systems disclosed without departing from the spirit of the invention and from the scope of the appended claims.

### DESCRIPTION OF THE PREFERRED EMBODIMENTS

When referring to the preferred embodiments, certain terminology will be utilized for the sake of clarity. Use of such terminology is intended to encompass not only the described embodiment, but also all technical equivalents which operate and function substantially the same way to bring about the same results.

Present invention employs a novel internal combustion-electric hybrid propulsion system, which substantially increases the flight range and the flight duration of any type, and any size airplane, manned or unmanned, and also provide for temporary silent stealth flight, and additional safety, which results in improved airplanes with many advantages.

This hybrid systems can be a parallel hybrid or a series hybrid and can use any desirable fuel. In combustion-only airplane the engine is designed for take-off and climbing power, but the engine is oversized for cruising power, and consumes too much fuel, and has no regeneration of energy and its storage, which results in low efficiency of the system. In these electric hybrids a small internal combustion engine is used only for cruising power and therefore can be approximately 2-3× smaller than the engine in an equivalent conventional airplane, and thus can run approximately 2-3× longer time on the same amount of fuel. This results in approximately 2-3× longer flight range.

The equivalent airplane is understood to be one having the same, or approximately the same size, weight and purpose. It is also understood that at least one or more than one of these hybrid propulsion systems can power the airplanes of the invention.

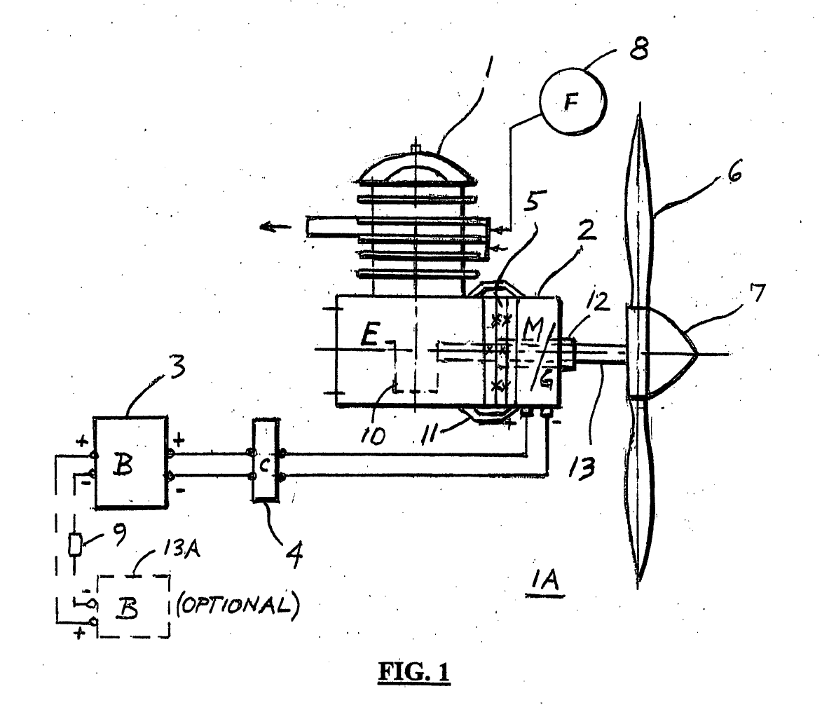

Referring now in more detail, particularly to the drawings of this patent and FIG. 1, one embodiment of this invention is the parallel internal combustion-electric hybrid propulsion system 1A, comprising internal combustion engine 1 with fuel tank 8, electric motor/generator 2, lithium based rechargeable battery 3 with controls 4, and electrically controlled clutch 5. The engine 1 includes crankshaft 10, and the motor/generator includes hollow shaft 12. The engine 1 and/or the electric motor/generator 2 in motor mode selectively drive the propeller 6 through the clutch 5 and shaft 13. Optional cone 7 may be attached to the propeller 6. Bridge 11 attaches the motor/generator 2 to the engine 1.

The propeller 6 can be puller type, or a pusher type.

When this parallel hybrid propulsion system 1A is installed into an airplane, the simplified operation of the parallel hybrid airplane is as follows:

For take-off and climb both, the electric motor/generator 2 and the combustion engine 1 are used to drive the propeller connected by the clutch 5. The electric motor 2 should be preferably powered by a high energy density rechargeable lithium-ion battery 3.

During horizontal flight, only the small engine 1 is used for cruising, and an extra power may be used to drive the generator 2 to generate electricity and recharge the batteries.

The clutch 5 may stay connected until the battery 3 is fully charged.

During descent, the engine 1 may be disconnected and stopped. The propeller 6 becomes a windmill and drives the electric motor/generator 2 and fully recharges the battery 3, if necessary, to be ready for the next take-off. It should be noted, that the final approach for landing should be done with the restarted engine, or electric motor, or both. The battery 3 is protected from overcharge by the controller 4, which in electric motor drive mode also controls the motor 2 per pilot's commands, and in an unmanned airplane via a radio, or a computer controls. Similarly, the electric clutch 5 is also controlled, as well as the start and stop of the engine 1.

This electric hybrid airplane has additional advantages useful to the military. It has a temporary stealth capability. It can fly a long range mission to the target using the engine, but during the approach it can switch to silent electric mode, execute the task and silently depart. For an extended silent electric flight, additional, optional, preferably lithium-air batteries 13A may be added with a switch or relay 9, at the cost of reducing the fuel range, which loss is replaced by the electric range. The electric motor 2 then restarts the engine via the clutch 5, to fly long distance back to the home base, becoming a generator and charges the battery 3 during the flight home. Added safety is in its electric power backed by the batteries, if the engine fails. The plane will not be lost.

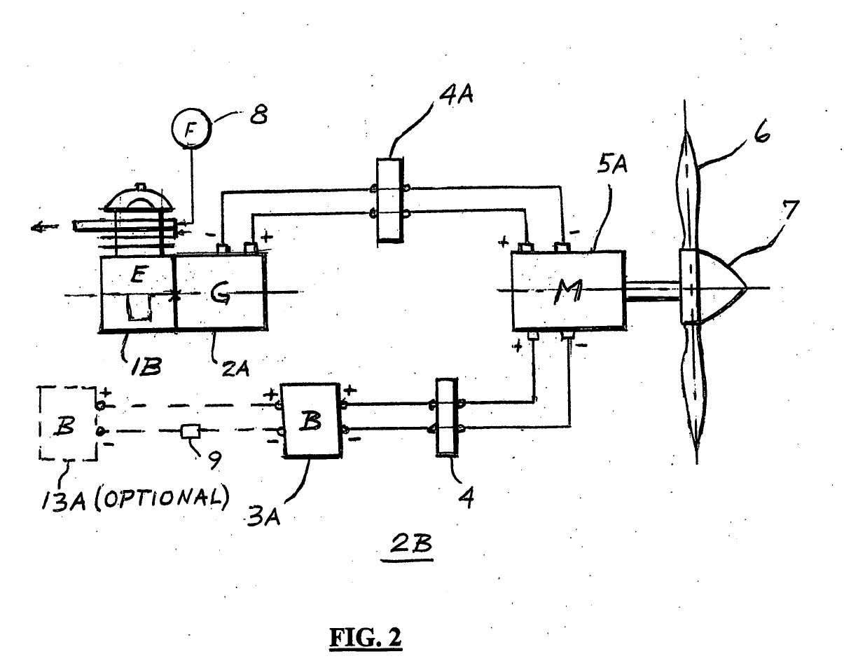

Another embodiment of the invention is shown in FIG. 2, which illustrates the series internal combustion-electric hybrid propulsion system 2B, comprising internal combustion engine 1B with electric generator 2A and fuel tank 8, battery 3A with controller 4, and electric motor 5A with controller 4A, which motor drives propeller 6 with optional cone 7. The propeller 6 can be puller type or pusher type. When this series hybrid propulsion system is installed into an airplane, the simplified operation of the series hybrid airplane is as follows:

During take-off and climb both, the engine/generator 1B and 2A and the battery 3A supplies electric current to the electric motor 5A, this drives the propeller 6. The electric motor is briefly overloaded approximately 3×.

During horizontal flight, only the generator 2A, driven by approximately 3× smaller engine 1, delivers electric current to the electric motor 5A and additionally charges the battery 3A, at approximately 3× lower fuel consumption rate.

Before the approach to the target, engine/generator 1B and 2A is stopped and silent flight continues by the electric motor 5A powered by the battery 3A. When the mission is completed, the aircraft silently departs on electric power only.

After a safe distance from the target, the generator 2A becomes second electric motor and restarts the engine 1B, which starts driving the generator 2A again, and recharges the battery 3A during the flight home.

During descent for landing, the engine/generator may be stopped. The propeller becomes a windmill and spins the first electric motor 5A, which becomes a second generator and fully recharges the battery if necessary, to be ready for the next take-off.

The battery is protected from overcharge by electronic control 4, and if necessary, it can be also charged on the ground from the electric grid by a well known charger. The same safety is provided by the battery back up, similar to the parallel hybrid. Also, the optional additional batteries 13A with a switch or relay 9 may be similarly added, for the extended silent flight.

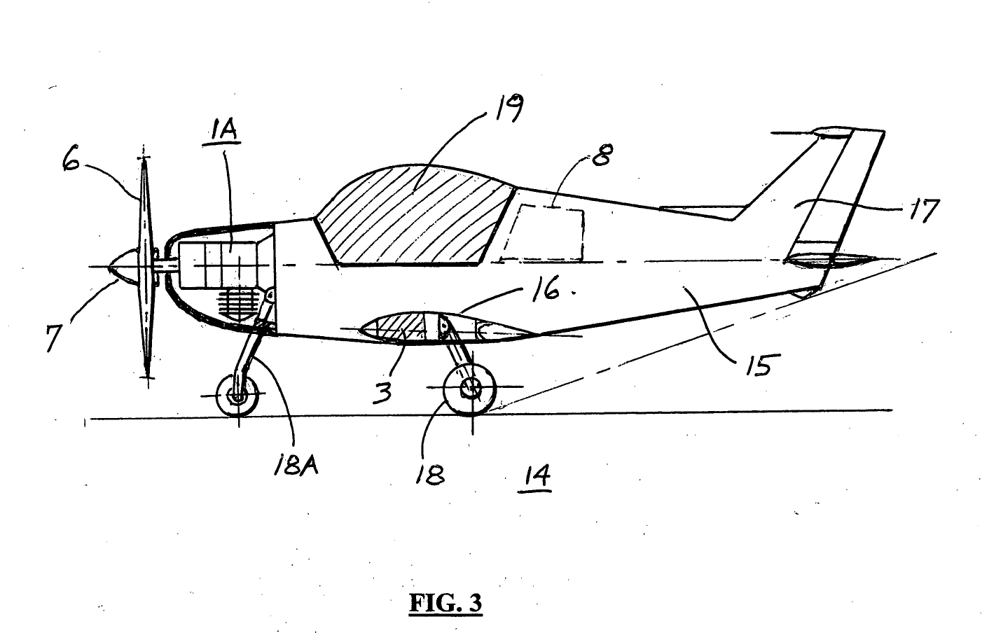

Another embodiment of the invention is shown in FIG. 3, which illustrates a fixed wing parallel hybrid monoplane 14 having the parallel hybrid electric propulsion system 1A installed, in the puller configuration, as an example. If should be noted, that any type of airframe, including gyrocopter (not shown) can be combined with this propulsion system. The airplane 14 also includes the fuselage 15, wing 16, empennage 17, landing gears 18 and 18A, fuel tank 8, and payload 19. The battery 3 is preferably in the wing 16. It is apparent, that this airframe configuration can also be combined with the series hybrid propulsion system 2B (not shown). In this case, only the electric motor SA would drive the propeller 6, and the engine/generator 1B-2A may be mounted in the fuselage 15.

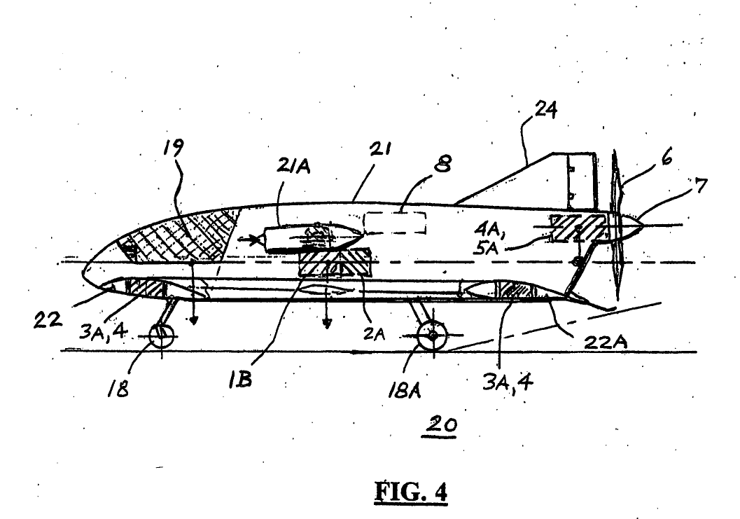

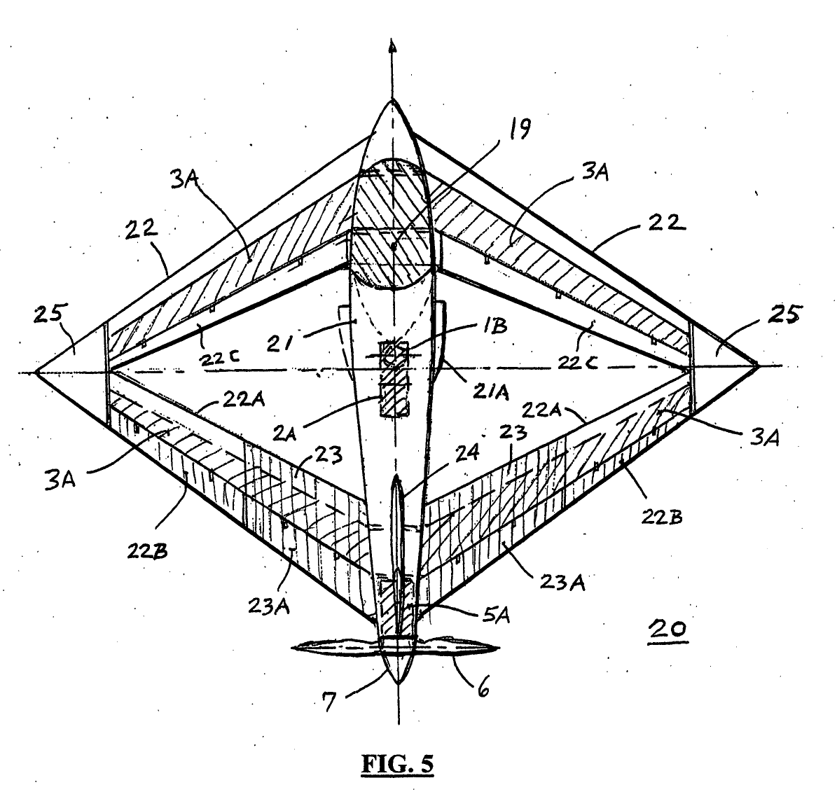

Another embodiment of the invention is shown in FIGS. 4 and 5, which illustrates a fixed wing series hybrid tandem-wing bi-plane 20, having the series hybrid electric propulsion system 2B installed in the pusher configuration, as an example. It should be noted that any type of airframe, including gyrocopter (not shown) can be combined with this propulsion system. The combination, as shown in FIGS. 4 and 5 also provides for a minimum drag, due to the smaller frontal section and the smaller wing span, and smaller induced drag, as compared to a conventional, equivalent airplane. All this also contributes to longer range and/or flight duration on the same amount of fuel. The airplane 20 comprises; fuselage 21, “diamond” wings 22 and 22A, horizontal control surfaces 23 and 23A, vertical tail 24, landing gears 18 and 18A, engine 1B with generator 2A, batteries 3A with controls 4, electric motor SA with pusher propeller 6 and controls 4A, fuel tank 8, and payload 19. The batteries 3A are mounted preferably in the wings to reduce the bending moment of the lift by their gravity force, which result in a lighter air-frame. The front wing 22 may have full span flaps 22C, and the horizontal control surfaces 23 and 23A of the rear wing 22A section should preferably have a symmetric airfoil. Asymmetric airfoil wing 22A has ailerons 22B. The induced drag of the wings is reduced due to having only two wing tips 25 as compared to a conventional bi-plane having four. The wings also have a high aspect ratio, as compared to a full delta wing, which again reduces the induced drag. Air inlets 21A are provided for cooling of the engine 1B.

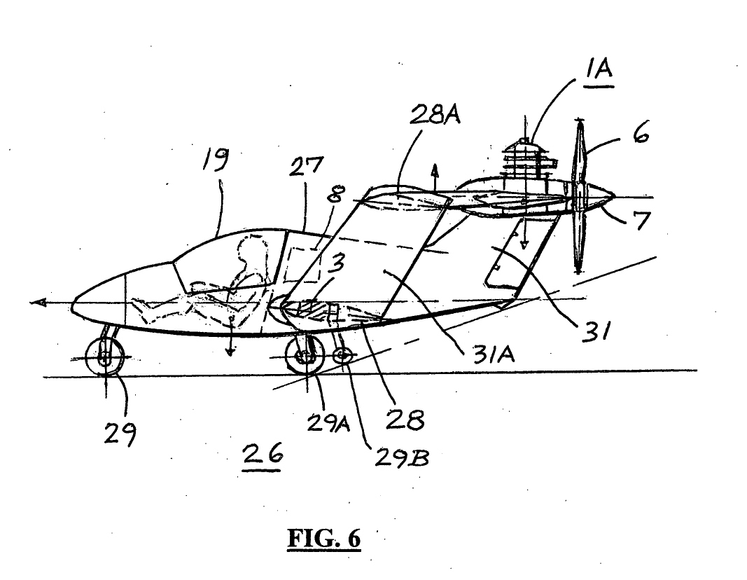

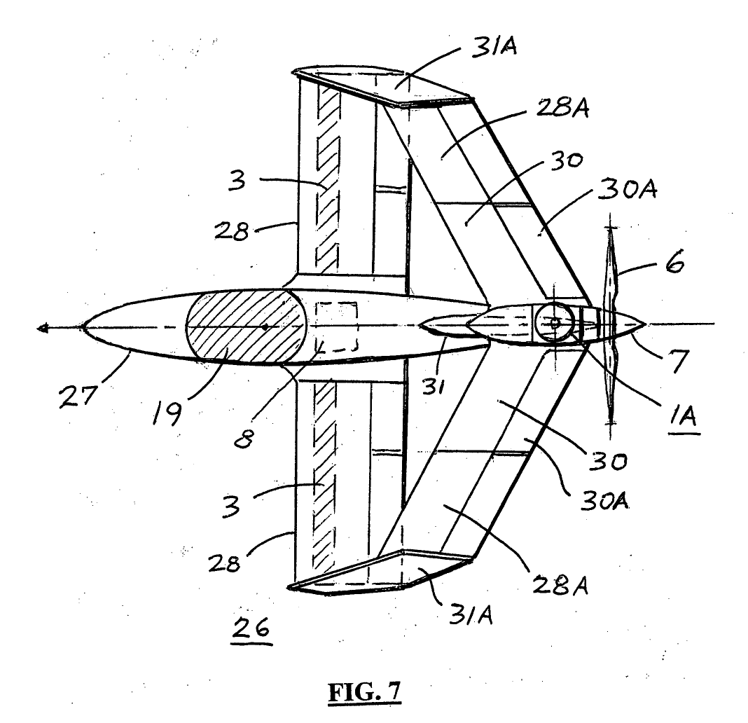

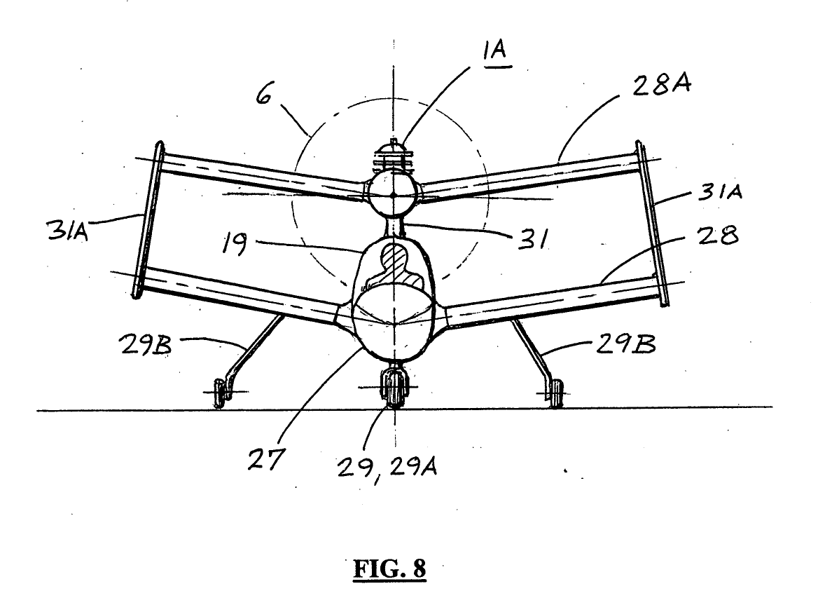

Another embodiment of the invention is shown in FIGS. 6-8 inclusive, illustrating unique bi-plane 26 having the parallel hybrid electric propulsion system 1A installed in the pusher configuration, as an example. It should be noted, that any type of airframe, including gyrocopter (not shown) can be combined with this propulsion system. The airplane 26 also comprises; fuselage 27, two wings 28 and 28A, landing gears 29 and 29A and 29B, horizontal control surfaces 30 and 30A, vertical tail 31, fuel tank 8, and payload 19. The advantage of this configuration is in having the pusher propeller 6 high on the end of the vertical fin 31, which eliminates the need for a high and heavy landing gear. Similarly, the rear wing section area with horizontal control surfaces 30 and 30A should have a symmetric airfoil, and the batteries 3 should be in the wings. The wings are connected by two vertical fins or braces 31A.

It is apparent to a person skilled in the art, that this airframe can be also combined with the series hybrid electric propulsion system 2B in the pusher configuration (not shown),similar to FIGS. 4 and 5. In this case, only the electric motor 5A with propeller 6 would be on the vertical fin 31, and the engine/generator 1B - 2A would be in the fuselage 27.

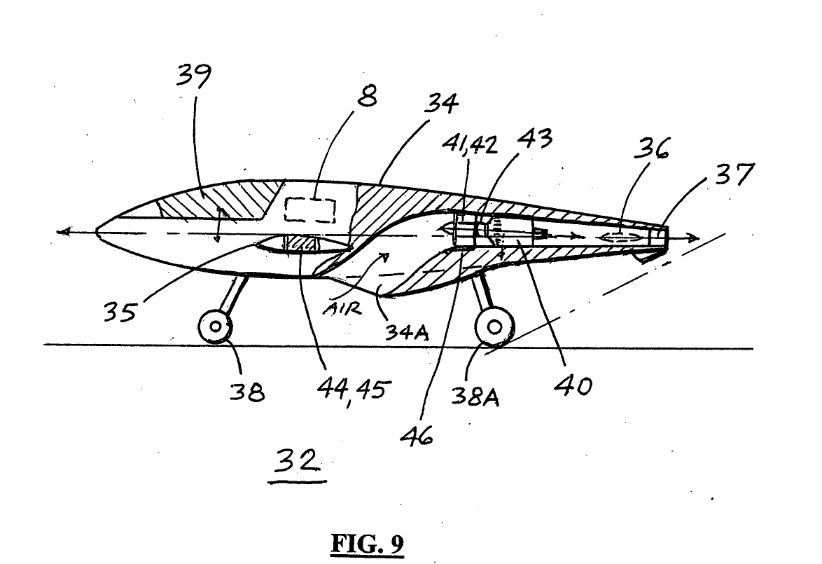

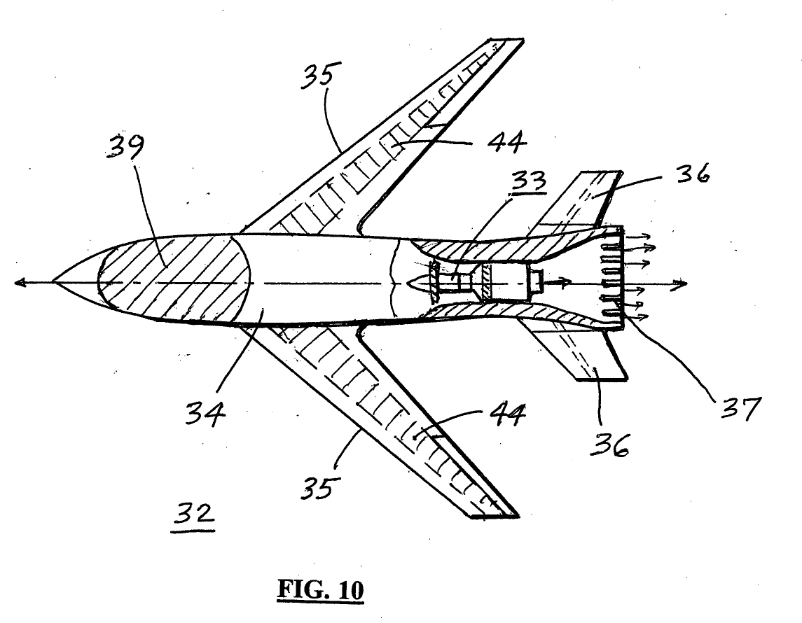

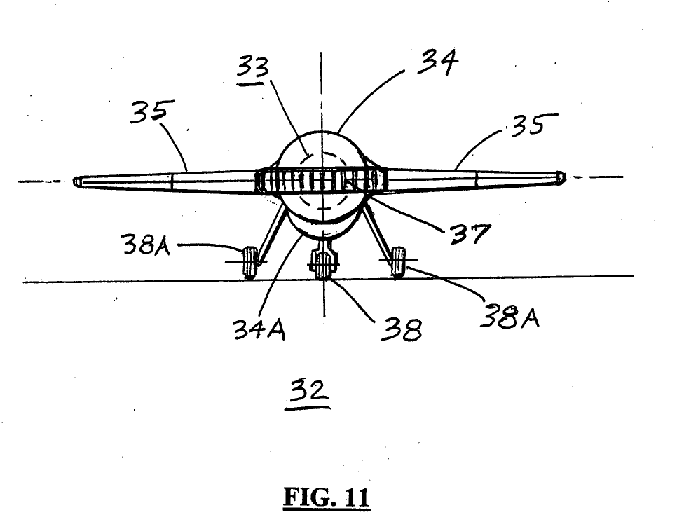

Another embodiment of the invention is shown in FIGS. 9-11 inclusive, illustrating a fixed wing monoplane 32, having a parallel jet engine-electric hybrid propulsion system 33 as an example. The airplane 32, which can be also used as a cruise missile, comprises: fuselage 34 with air inlet 34A, wing 35, horizontal control surfaces 36, vertical vectoring louvres 37 at the tail end of the fuselage 34, (having the same section area size as the middle fuselage section area size), landing gears 38 and 38A, fuel tank 8, and payload 39. The propulsion system 33 is mounted in the fuselage 34 and comprises: jet engine 40, preferably series type electric motor/generator 41 with fan 42, electric clutch 43 between the motor/generator 41 and the jet engine 40, preferably lithium rechargeable battery 44, and electric motor controls 45. The electric fan 42 can have over 30K RPM and is enclosed in cylindrical duct or ring 46; which may have the same inside diameter as the ring of the jet engine 40. The air enters the inlet 34A, then the fan 42, and then the jet engine 40. The jet exhaust propels the airplane by exiting through the vertical louvers 37, which are used for directional control, thus eliminating the conventional vertical fin and rudder, and reducing drag. The clutch 43 has the same function as the clutch 5 in the parallel hybrid system 1A described above. In the electric mode the ducted fan 42 propels the airplane. The operation and the advantages of this parallel hybrid airplane are identical as described for the parallel hybrid system 1A. In another version of the parallel hybrid system, the fan 43 is omitted and the axial compressor of the jet engine 40, driven by the electric motor 41 in the electric mode is then used to propel the airplane.

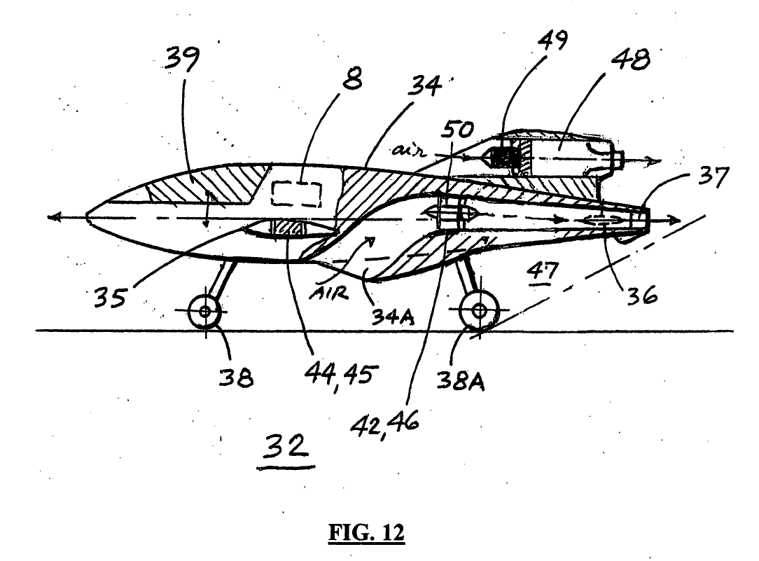

The similar type airframe can be also combined with a jet engine-electric series hybrid propulsion system 47, as shown in FIG. 12, similar to the system 2B and has the same operational characteristics as described for the series hybrid system 2B. Similarly, jet engine 48 (replacing the engine 1B)drives the generator 49 (replacing the generator 2A), and series electric motor 50 (replacing the motor SA) drives the ducted fan 42 (replacing the propeller 6). When the above airplanes are used in the electric mode as cruise missiles, they will achieve a total surprise.

The above described propulsion systems without the fuel should not weigh more than the equivalent, large conventional combustion-only equivalent aircraft engines. To accomplish this: The small engine, electric motor/generator, and batteries should be redesigned and made from ultra-lightweight materials only. For example: magnesium alloy engine crankcase and electric motor and generator casings, carbon-carbon composite cylinder block with a ceramic lining(s), aluminum and/or titanium hollow shafts, ceramic bearings, lithium based batteries, and disc armature high torque electric motor/generator may have flat aluminum wires or copper plated graphite fiber wires instead of copper. Flight controls of all control surfaces, like ailerons, flaps, elevators, rudders, louvers and clutches, engines and motor power controls etc. should be preferably all electric, and may be also remote radio and/or computer controlled.

In case of hydrogen fuel, these airplanes would fly about the same distance as an equivalent conventional plane with petroleum fuel, due to their efficiency, and at much lower production cost than a fuel cell hydrogen fueled airplane. The hybrid electric airplanes of the invention can be built in any size, from micro-unmanned air verticals (MUAV's) up to large manned cargo planes and airliners, and can have any type of airframe.

It should, of course be understood that the description and the drawings herein are merely illustrative and it will be apparent that various modifications, combinations and changes can be make of the structures disclosed without departing from the spirit of the invention and from the scope of the appended claims.

It will thus be seen that a safer, longer flight range and longer flight duration airplanes with silent flight capability have been provided with which the objects of the invention are achieved.

I claim:

1. Parallel internal combustion-electric hybrid propulsion system for airplanes, comprising:
a smaller internal combustion engine than an internal combustion engine of an equivalent internal combustion-only airplane;
an electric motor/generator in one unit;
an electric control unit for controlling said motor;
an electric clutch between said engine and said motor/generator;
at least one battery electrically connected to said motor/generator through said control unit;
a propeller which can be driven by said engine, or by said electric motor, or by both, selectively through said clutch;
and a fuel storage.

2. Series internal combustion-electric hybrid propulsion system for airplanes, comprising:
a smaller internal combustion engine than an internal combustion engine of an equivalent internal combustion-only airplane, and said smaller engine drives an electric generator;
an electric motor which drives a propeller;
a first electric control unit for controlling said motor;
at least one battery electrically connected to said motor through said first control unit;
a second electric control unit for controlling said motor, electrically connected to said motor and to said generator;
and a fuel storage.

3. Internal combustion-electric hybrid airplane with a puller propeller, which airplane comprises:
an airframe with flight controls;
at least one parallel hybrid electric propulsion system as described in claim 1;
and a payload.

4. Internal combustion-electric hybrid airplane with a push propeller, which airplane comprises:
an airframe with flight controls;
at least one parallel hybrid electric propulsion system as described in claim 1;
and a payload.

5. Internal combustion-electric hybrid airplane with a puller propeller, which airplane comprises;
an airframe with flight controls;
at least one series hybrid electric propulsion system as described in claim 2;
and a payload.

6. Internal combustion-electric hybrid airplane with a pusher propeller, which airplane comprises:
an airframe with flight controls;
at least one series hybrid electric propulsion system as described in claim 2;
and a payload.

7. Hybrid electric airplane as described in claim 4, in which said airplane is a bi-plane having a fuselage, first wing and second wing and a vertical tail fin, said wings are connected together with braces, and in which said engine, said clutch and said electric motor/generator with said pusher propeller are mounted on top of said vertical tail fin, together with said second wing, and said second wing includes horizontal control surfaces, said surfaces having a symmetric airfoil profile.

8. Hybrid electric airplane as described in claim 6, in which said airplane is a bi-plane having a fuselage, first wing and second wing, and a vertical tail fin, said wings are connected together with braces, and in which said electric motor with said pusher propeller are mounted on top of said vertical tail fin, together with said second wing, and said engine with said generator are mounted in said fuselage, and said second wing includes horizontal control surfaces, said surfaces having a symmetric airfoil profile.

9. Hybrid electric airplane as described in claim 6, in which said airplane is a diamond wing tandem bi-plane having a fuselage with a tail end, front wing and rear wing, said wings are connected together at their tip ends, and in which said electric motor with said pusher propeller are mounted at said fuselage tail's end, and said engine with said generator are mounted in said fuselage, and said rear wing includes horizontal control surfaces, said surfaces having a symmetric airfoil profile.

10. Hybrid electric airplane as described in claims 3, or 6, in which said engine is a jet engine, and in which said propeller is replaced with a ducted fan.

11. Hybrid electric airplane as descried in claim 3, or 4, or 5, or 6 in which said airframe includes at least one wing and said batteries are mounted in said wing(s).

12. Hybrid electric airplane as described in claims 3, or 4, or 5, or 6, which is a cruise missile, and in which said engine is a jet engine and in which said propeller is replaced with a ducted fan.

13. Hybrid electric propulsion system for airplanes, as described in claims 1, or 2, in which said engine includes magnesium alloy crankcase, carbon/carbon composite cylinder block and head with ceramic lining(s), titanium hollow crankshaft, and ceramic bearings; and said electric motor and said generator include magnesium alloy casings, aluminum hollow shaft, flat aluminum wires, and ceramic bearings; and said battery is a lithium based battery.

14. Hybrid electric propulsion system for airplanes as described in claims 1, or 2, in which said fuel is hydrogen.
